(19) United States
(12) Patent Application Publication
(10) Pub. No.: US 2021/0386618 A1
(43) Pub. Date: Dec. 16, 2021

(54) VIBRATORY POOL NOODLE

(71) Applicant: Karl W. Gutmann, Plantation, FL (US)

(72) Inventor: Karl W. Gutmann, Plantation, FL (US)

(21) Appl. No.: 17/460,790

(22) Filed: Aug. 30, 2021

(51) Int. Cl. A61H 23/02

(52) U.S. Cl. CPC A61H 23/0254; A61H 2201/0115; A61H 2201/1609; A61H 2201/0157

(57) ABSTRACT

A vibratory pool noodle for supporting a user to remain afloat in water and also provides vibration massage to different body parts of the user. The vibratory pool noodle includes an outer core made from a buoyant material, the outer core is hollow, the outer core of a prolonged tubular shape having a proximal end and a distal end; an inner core encased in the outer core, the inner core made of a pliable material; and a vibration motor encased in the outer core, the vibration motor impart vibrations to the vibratory pool noodle which in turn can transfer the vibrations to the one or more body parts of the user in contact with the vibratory pool noodle for massaging the one or more body parts.

### CROSS-REFERENCE TO RELATED APPLICATIONS

This application claims priority from a U.S. provisional patent application Ser. No. 63/060,328, filed on Aug. 3, 2020, which is incorporated herein by reference in its entirety.

### FIELD OF INVENTION

The present invention generally relates to a vibratory pool noodle as a cylindrical buoyant device, and more particularly, the present invention relates to a pool noodle to support a person to remain afloat in water and provide for vibration massage to various parts of the body while being afloat in the water.

### BACKGROUND

Workers tirelessly manage full-time careers with long commutes just to arrive home and perform unavoidable daily chores. Moreover, people can get stressed due to a variety of activities, such as sports, daily chores, or any physical activity. The tired persons generally look for different ways to relax. Lying afloat in a swimming pool is one of the popular means to relax the body. However, remaining afloat in the swimming pool has limited positive effects on the body and could not cope with increasing levels of stress in normal lives.

Thus, a desire is always there for better means to relax the body and mind, and to relieve the body from induced stress.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is directed to a vibratory pool noodle that can aid a person to remain afloat in water. However, it is to be understood that the present invention may not be used as a life saving devices, in emergencies, or as a personal floatation device.

It is another object of the present invention that the vibratory pool noodle can simultaneously provide vibratory massage to body parts while being afloat in the water.

It is still another object of the present invention that the vibratory pool noodle can help to relieve stress and tension more efficiently than lying afloat in a swimming pool or massage alone.

It is a further object of the present invention that the vibratory pool noodle can be easily adapted to different shapes for massaging different parts of the body.

It is still a further object of the present invention that the vibratory pool noodle is economical to manufacture.

It is yet a further object of the present invention that the vibratory pool noodle is safe to use in water.

It is an additional object of the present invention that the vibratory pool noodle is compact and portable.

In one aspect, disclosed is a vibratory pool noodle and a method of use thereof to relax the body and relieve stress and tension from different body parts. The vibratory pool noodle can include a hollow outer core and an inner core, wherein the inner core can be encased within the hollow outer core. The outer core can be made of a buoyant material that provided the vibratory pool noodle the ability to support a person to remain afloat in water. The inner core can be made from a pliable material that allows the vibratory pool noodle to maintain its shape under minor force but can bend under larger force. The inner core encases a vibration motor which when operated can result in the vibratory pool noodle vibrating, wherein the vibrations can be transferred to an object coming in contact with the outer surface of the vibratory pool noodle.

In one aspect, the vibratory pool noodle can be manufactured in the form of a prolonged tubular shape. Additionally, the outer core can be symmetrical about a longitudinal axis.

In one aspect, a cap can be provided on one end of the vibratory pool noodle, wherein control buttons can be there in the cap for turning the vibration motor on and off and also adjust the frequency of the vibrations. Also, a charging port can be provided in the cap for charging a battery also enclosed within the outer core. The cap can be sealably coupled to an open end of the outer core.

In one aspect, disclosed is a method for self-gratification by placing the vibratory pool noodle near genitalia.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a vibratory pool noodle shown applied to a neck of a user, according to an exemplary embodiment of the present invention.

FIG. 2 shows the vibratory pool noodle applied to the waist of the user, according to an exemplary embodiment of the present invention.

FIG. 3 shows the vibratory pool noodle between the user's groin for sexual arousal, according to an exemplary embodiment of the present invention.

FIG. 4 is an exploded view of the vibratory pool noodle, according to an exemplary embodiment of the present invention.

FIG. 5 is a cross-sectional view along the longitudinal axis of the vibratory pool noodle, according to an exemplary embodiment of the present invention.

FIG. 6 is an enlarged view of section 4 in FIG. 3, according to an exemplary embodiment of the present invention.

FIG. 7 is an enlarged view of section 5 in FIG. 3, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a vibratory pool noodle that can aid a person to remain afloat in water and provide vibratory massage to different body parts of the user while being immersed in the water. The disclosed vibratory pool noodle can massage a portion of the user's body while being in a swimming pool or a similar water body. The vibrations can be optional and could be turned off or the intensity of the vibrations can be adjusted between predetermined levels. Additionally, the vibratory pool noodle can also provide for sexual arousal by placing the vibratory pool noodle near particular areas of the user's body.

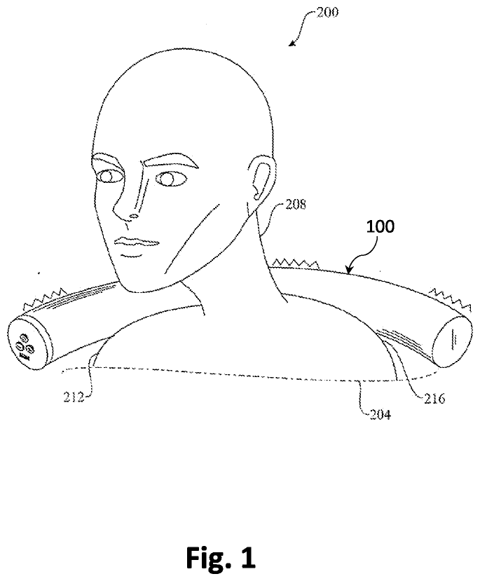

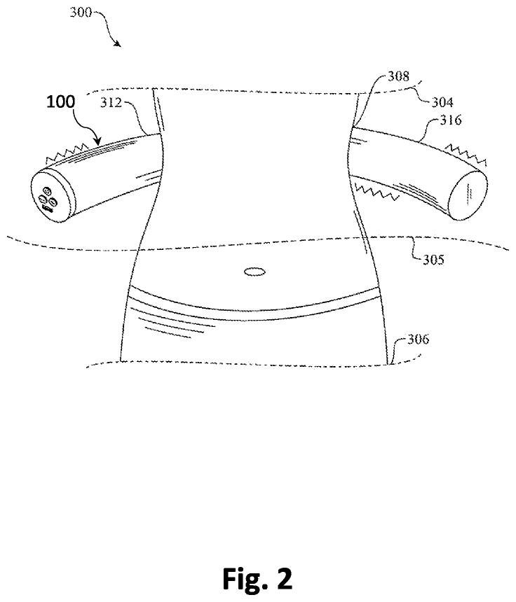

Referring to FIG. 1 which shows an exemplary embodiment of the vibratory pool noodle 100 of a prolonged tubular shape that is symmetrical along its longitudinal axis. The vibratory pool noodle can have a proximal end and a distal end along its length. FIG. 1 shows the vibratory pool noodle 100 being worn by a user 200 wherein the vibratory pool noodle 100 is in touch with neck 208, left shoulder 212, and right shoulder 216 of the user 200. Broken line 204 shows the water level, wherein user 200 is immersed in the water up to his shoulders. Similarly, the vibratory pool noodle 100 can be applied to other body parts for vibratory massage, wherein the person can lay down in different positioning in the water supported by the vibratory pool noodle. For example, FIG. 2 shows user 300 having the vibratory pool noodle 100 applied over the waist above the buttocks. User 300 is shown immersed in water up to chest 304. The vibratory pool noodle 100 can float as well as be immersed in the water depending on the way the vibratory pool noodle 100 is used. If the user immerses himself in water from the chest down 304, then the vibratory pool noodle 100 can also be immersed in water. However, if the user 300 immerses himself in water from either the waist down 305 or the legs down 306, the vibratory pool noodle 100 can also be above water. The right portion 316 of the vibratory pool noodle 100 lies on the right side of the user 300 and the left portion 312 can extend outwards from the left side of the user 300. As shown in FIGS. 1 and 2, the user can use the vibratory pool noodle 100 on different body parts for the massage. The user can practice predefined ways to use the disclosed vibratory pool noodle 100 as well as experiment with new ways to use the vibratory pool noodle 100 in a pool. The outer surface of the vibratory pool noodle 100 can be made from soft and skin-friendly material. Moreover, a user can use more than one vibratory pool noodle 100 simultaneously for different body parts.

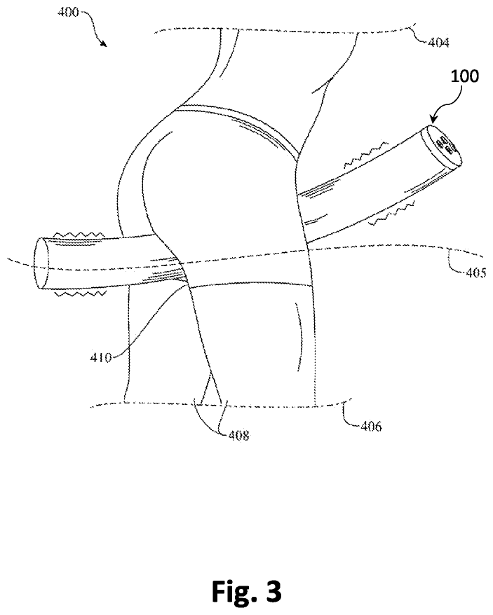

Referring to FIG. 3 which shows a user 400 in a swimming pool or similar water body and having either the chest down 404, or the legs down 405, or the knees down 406. The user can straddle the vibratory pool noodle 100 between the legs 408 such as the vibratory pool noodle 100 can be in contact with the user's groin region 410. By straddling the vibratory pool noodle 100 and placing it in between the legs 408 and near the groin region 410, the user 400 can use the pool noodle 100 for sexual arousal and self-gratification. The user 400 can adjust the aggressiveness of the massage by adjusting the vibration frequency.

In different positions, the pool noodle can be fully immersed or submerged. The vibratory pool noodle 100 can be operated both in and out of the water. The vibrations from the vibratory pool noodle can be felt both into and outside the water, while in the water, the vibratory pool noodle can also support a person to afloat. Once the user is done with the massage, the vibration motor can be turned off and the user can continue to use the vibratory pool noodle as a conventional flotation device.

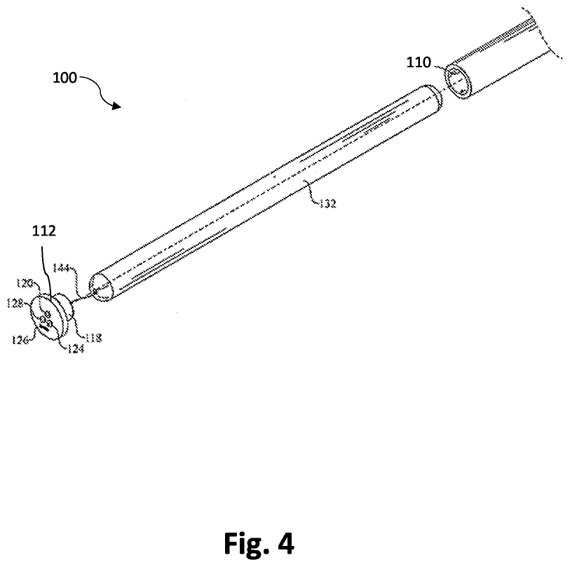

Referring to FIG. 4 which is an exploded view of the vibratory pool noodle 100 having an outer core 110, which can basically be a hollow sheath made from a buoyant material that can keep the vibratory pool noodle 100 afloat in the water as well can optionally support a person to remain afloat or submerged in the water. In one case, the outer core 110 can be made from a buoyant material, such as expanded polyethylene or nitrile rubber. The material of the outer core can be waterproof and skin friendly. Moreover, the surface of the outer core that comes in contact with skin can offer a certain clench that does not slip when grasped or applied to the body part. The outer core can be of a prolonged tubular shape that is symmetrical along the longitudinal axis. However, any other shape of the vibratory pool noodle is within the scope of the present invention.

The outer core is enclosed from all sides except one end through which an inner core 132 can be inserted into the hollow outer core. The open end of the outer core can be sealably covered by a cap 112. The seal can be a watertight seal that prevents entry of water into the hollow interior of the outer core when the vibratory pool noodle is immersed in water. The cap 112 can fit into the open end of the outer core. The cap can also include a power button 120 that can be used to turn a vibration motor on and off. The button can be a push-button or a touch button. The cap can include different controls in the form of buttons to control the functions of the vibration motor, such as button 124 can be used to increase the vibration frequency while button 128 can be used to decrease the vibration frequency. The cap 112 can also include a charging port 126 that can be used to charge a battery also enclosed within the outer core. Additionally, remote control can also be provided for changing the vibration frequency as well as to turn the vibrations on and off. In one case, the remote control can be configured as a wristband that can be worn by the user. The vibratory pool noodle can include a wireless connection means, such as a Bluetooth° that allows connecting the remote control to the vibratory pool noodle.

The internal core 132 can be encased within the outer core and can be made from any pliable material. The pliable material of the internal core allows the vibratory pool noodle 100 to be bent such that it can easily conform to the back or other body parts of a user. The vibration motor can also be enclosed within the outer core, wherein an electrical wire can connect the vibration motor to the controls in the cap. FIG. 4 shows a narrow passage in the internal core 132 through which the wire can pass through. The vibration motor can be powered by a battery also enclosed within the outer core. In one case, the battery can be a rechargeable battery, such as a Lithium metal battery wherein a charging circuitry connected to the charging port 126 can be provided to charge the battery. The charging circuitry can also provide an indication for low battery, such as an LED can be provided which can indicate low battery.

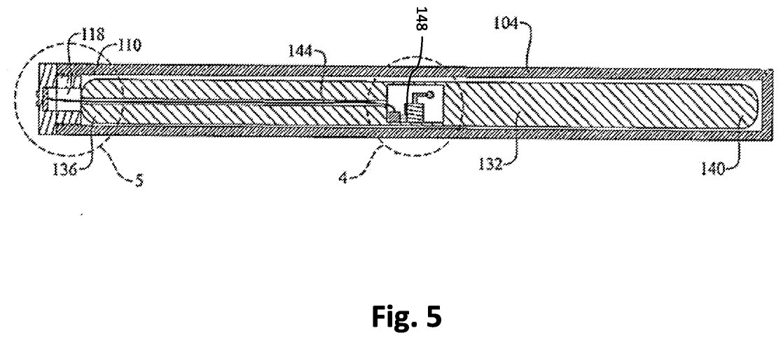

Referring to FIG. 5 which is a cross-sectional view of the vibratory pool noodle along the longitudinal axis. FIG. 5 shows the inner core 132 encased within hollow outer core 104 and a vibration motor 148 enclosed within the inner core 132. The inner core 132 can include a proximal end 136 and a distal end 140. The proximal end 136 of the inner core can be adjacent to the plug 118 of the cap 112. The vibration motor 148 within the inner core 132 can act as the primary mechanism that allows the vibratory pool noodle 100 to vibrate. The vibration motor 148 can be connected through an electrical wiring 144 that runs from the cap 112 to the vibration motor 148. In alternative embodiments, the vibration motor 148 may engage with the cap through a wireless connection, such as Bluetooth.

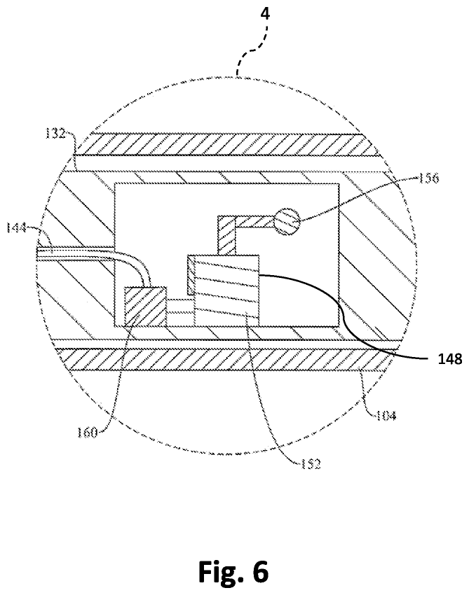

FIG. 6 in an enlarged view of section 4 in FIG. 5. The vibration motor 148 and its component parts can be seen in FIG. 6. In one case, the vibration motor 148 may be a coreless DC cylindrical motor. The vibration motor 148 can be enclosed with the inner core 132. The vibration motor 148 may include a weight 156, a casing 152 which houses a rotor and stator, and a power supply 160. Such a motor vibrates due to a purposeful improper balance between the weight 156 and the rotational shaft in the casing 152. The weight 156 is attached to the motor's rotational shaft that produces a centrifugal force while rotating. The unbalanced force displaces and under high speeds, makes the motor wobble which causes the vibration. In alternate embodiments, the power supply may be battery operated, eliminating the need for any electrical wiring 144.

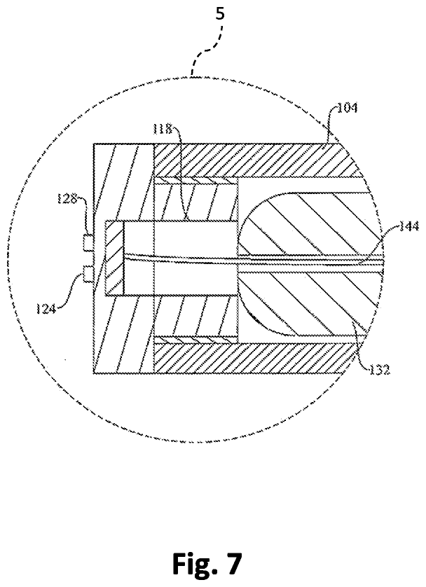

Referring to FIG. 7 which is an enlarged view of section 5 in FIG. 5 showing the cap. The cap 112 includes a plug 118 that is inserted into the open end of the outer core 110 at the proximal end. In alternate embodiments, the plug 118 may include various types of locking mechanisms such as a pin, clamp, cam lock, or other threaded fasteners.

In one exemplary embodiment, the vibration motor 148 can be an egg shaped coin-type vibration motor. The vibration motor may include a case, a bearing, a shaft, a magnet, a brush, and a coil assembly. The coils are energized by a brush which produces a magnetic field strong enough to interact with the ring magnet integrator into the stator, causing rotation. A force is generated due to the magnetic field, causing the weight to displace which is felt as a vibration.

In one exemplary embodiment, is disclosed a method for vibrations massage, the method includes the steps of applying the vibratory pool noodle to desired body parts, such as around the shoulder or waist. The user can relax in the swimming pool supported by the vibratory pool noodle. The power button can then be turned on to power the vibration motor 148 resulting in the vibratory pool noodle 100 beginning to vibrate. The user can massage their neck or other body part and the desired level of vibrations can be adjusted by increasing or decreasing the vibration frequency. Once the user is done with the massage, they can turn off the vibration motor by pressing the power button. At that point, the user may continue to use the pool noodle as a conventional flotation device.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A vibratory pool noodle comprising:
an outer core made from a buoyant material, the outer core is hollow, the outer core of a prolonged tubular shape having a proximal end and a distal end;
an inner core encased in the outer core, the inner core made of a pliable material; and
a vibration motor encased in the outer core, the vibration motor configured to impart vibrations to the vibratory pool noodle, wherein the vibratory pool noodle configured to transfer the vibrations to one or more body parts of a user in contact with the vibratory pool noodle for massaging the one or more body parts.

2. The vibratory pool noodle according to claim 1, wherein the proximal end of the outer core is having an open end, wherein a cap sealably covers the open end.

3. The vibratory pool noodle according to claim 2, wherein the cap comprises:
a power button, wherein the power button in electrical communication with the vibration motor and configured to turn the vibration motor on and off;
a charging port, the charging port in electrical communication with a charging circuitry, the charging circuitry configured to a charge a battery also enclosed within the outer core, the battery powers the vibration motor; and
one or more control buttons in electrical communication with the vibration motor for increasing or decreasing a vibration frequency of the vibration motor.

4. The vibratory pool noodle according to claim 1, wherein the outer core is configured to support the user to remain afloat in water.

5. The vibratory pool noodle according to claim 4, wherein the inner core permits the vibratory pool noodle to be bent under an external force.

6. The vibratory pool noodle according to claim 1, wherein the outer core is made of expanded vinyl coated polyethylene or nitrile rubber.

7. The vibratory pool noodle according to claim 1, wherein the vibration motor is an egg-shaped coin type vibration motor.
